(19) United States
(12) Patent Application Publication
(10) Pub. No.: US 2010/0277650 A1
(43) Pub. Date: Nov. 4, 2010

(54) SCENE-CHANGE DETECTION DEVICE

(75) Inventor: Hiroshi MATSUZAKI, Tokyo (JP)

Correspondence Address: SCULLY SCOTT MURPHY & PRESSER, PC, 400 GARDEN CITY PLAZA, SUITE 300, GARDEN CITY, NY, 11530, US

(73) Assignee: OLYMPUS CORPORATION, Tokyo (JP)

(21) Appl. No.: 12/833,530

(22) Filed: Jul. 9, 2010

Related U.S. Application Data
(63) Continuation of application No. PCT/JP2008/070784, filed on Nov. 14, 2008.

(30) Foreign Application Priority Data
Jan. 9, 2008 (JP) 2008-002183

(51) Int. Cl. H04N 5/14

(52) U.S. Cl. 348/700; 348/E05.062

(57) ABSTRACT

A scene-change detection device detects a scene change image from a continuous image sequence on the basis of an amount of change among a plurality of images. The scene-change detection device includes a feature-region extracting unit that extracts a feature region from an image in the image sequence; and a detecting unit that sets a condition of image-to-image change detection on the basis of a feature amount of the feature region extracted, calculates an image-to-image change amount, and detects a change among a plurality of images.

### CROSS-REFERENCE TO RELATED APPLICATIONS

This application is a continuation of PCT international application Ser. No. PCT/JP2008/070784 filed on Nov. 14, 2008 which designates the United States, incorporated herein by reference, and which claims the benefit of priority from Japanese Patent Application No. 2008-002183, filed on Jan. 9, 2008, incorporated herein by reference.

### BACKGROUND OF THE INVENTION

1. Field of the Invention

The present invention relates to a scene-change detection device for detecting a scene change image at the position where a scene is changed in a sequence of continuously-taken images or a sequence of frame images of a moving image.

2. Description of the Related Art

A moving image is composed of a sequence of an enormous number of continuous images, and to create a summary image sequence by detecting useful images from the sequence of continuous images is a useful technical field. Much the same is true of a sequence of continuously-taken still images. For example, an in-vivo image taken with a capsule endoscope is taken about every 0.5 second from when the capsule endoscope is swallowed through the mouth until the capsule endoscope is carried out of the body, and a sequence of about 60000 continuous images is obtained. These images are images of the digestive tract taken sequentially, and displayed on a workstation or the like and observed to give a diagnosis. However, it takes more than an hour to sequentially observe all the images, i.e., as many as about 60000 images, so it is hoped a technique for conducting an observation efficiently will be proposed.

Conventionally, various methods for detecting an image at the position where a scene is changed (a scene change image) from a sequence of continuous images like a moving image have been proposed. It is conceivable that such a scene change image is used to efficiently conduct an observation of large quantities of images. As a method for detecting a scene change image, for example, there is generally well known a method of comparing an amount of change in feature between adjacent images (frames) with a predetermined threshold and detecting the image as a scene change image if the amount of change in feature exceeds the threshold.

Furthermore, there is an example of a proposal enabling to make a change to a generated scene change image sequence by providing an input means for changing a threshold of an inter-frame change and setting a desired threshold selected from a plurality of thresholds (for example, see Japanese Laid-open Patent Publication No. 2006-41794).

### SUMMARY OF THE INVENTION

A scene-change detection device according to an aspect of the present invention is for detecting a scene change image from a continuous image sequence on the basis of an amount of change among a plurality of images. The scene-change detection device includes a feature-region extracting unit that extracts a feature region from an image in the image sequence; and a detecting unit that sets a condition of image-to-image change detection on the basis of a feature amount of the feature region extracted, calculates an image-to-image change amount, and detects a change among a plurality of images.

A computer readable recording medium according to another aspect of the present invention includes programmed instructions for detecting a scene change image from a continuous image sequence on the basis of an amount of change among a plurality of images. The instructions, when executed by a computer, cause the computer to perform extracting a feature region from an image in the image sequence; setting a condition of image-to-image change detection on the basis of a feature amount of the feature region extracted, calculating an image-to-image change amount; and detecting a change among a plurality of images.

The above and other features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a functional block diagram illustrating a configuration of a scene-change detection device according to a first embodiment of the present invention;

FIG. 2 is a schematic flowchart illustrating a procedure of a scene-change detection process according to the first embodiment;

FIG. 3 is a schematic flowchart illustrating a more detailed process example of processes at Steps S105 and S106 in FIG. 2;

FIG. 4 is a schematic explanatory diagram illustrating how, for example, three images in a continuous image sequence are extracted in time-series order;

FIG. 5 is a schematic diagram illustrating a difference in change among five continuous images A to E between when a region feature is not considered as in conventional technologies and when the region feature is considered as in the first embodiment;

FIG. 6 is a schematic diagram illustrating an example of an image sequence from which a scene change image is detected;

FIG. 7 is a schematic flowchart illustrating a processing example according to a second embodiment of the present invention; and

FIG. 8 is a configuration diagram schematically illustrating a capsule endoscope system including a scene-change detection device according to an example as a workstation.

### DETAILED DESCRIPTION OF THE PREFERRED EMBODIMENTS

A scene-change detection device and a scene-change detection program as best modes for carrying out the present invention are explained below with reference to the accompanying drawings. The present invention is not limited to embodiments described below, and various variants can be made without departing from the scope of the present invention.

### First Embodiment

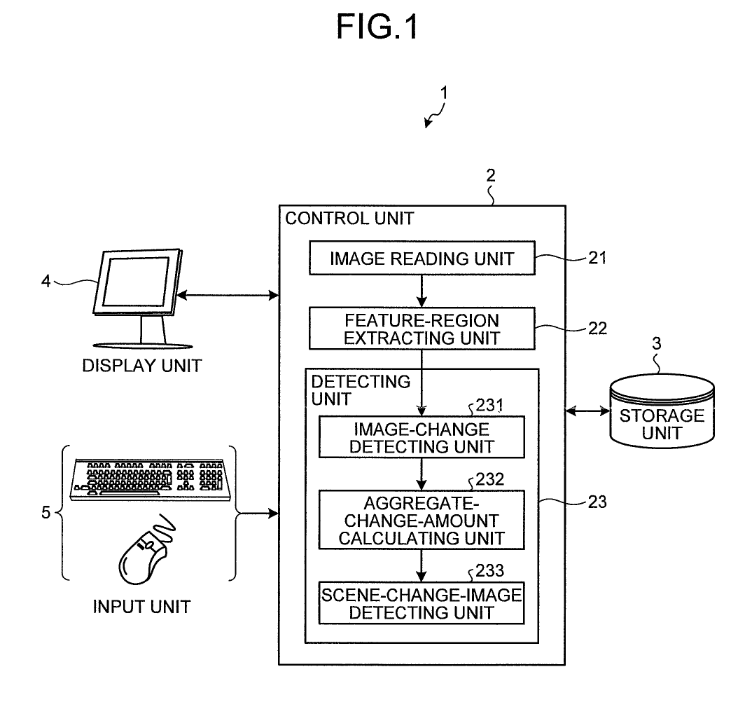

FIG. 1 is a functional block diagram illustrating a configuration of a scene-change detection device according to a first embodiment of the present invention. A scene-change detection device 1 shown in FIG. 1 is realized by a computer including hardware, such as a CPU, a ROM, and a RAM, and includes a control unit 2, a storage unit 3, a display unit 4, and an input unit 5.

The control unit 2 schematically includes a calculating function and a control function. The storage unit 3 stores therein image information on a sequence of time-series continuous images like a moving image, and is composed of a database and the like. The display unit 4 is composed of an LCD, an ELD, a CRT, or the like, and displays various information including images of a scene change image sequence (a summary image sequence), a processing result, on a display screen thereof. The input unit 5 is composed of a keyboard, a mouse, a pointer, and the like, and an input operation of various information or an instruct operation for processing an image is performed through the input unit 5.

The control unit 2 includes an image reading unit 21, a feature-region extracting unit 22, and a detecting unit 23. The image reading unit 21 reads images in the continuous image sequence stored in the storage unit 3. The feature-region extracting unit 22 extracts at least one feature region from each of the images sequentially read by the image reading unit 21 by using the existing feature-region extraction technology, which results in dividing a whole area of a target image into a plurality of regions. The extraction of a feature region in the present embodiment is a concept including recognition of the feature region. The recognition of the feature region can be made in such a way that the whole area of the target image is divided into a plurality of regions, and a process of setting a level of importance with respect to each of the regions on the basis of a feature of each region or the like is performed to associate with a level of importance. The feature region means, for example, a portion of an image showing a feature of the image or a desired object on the image on an image-to-image basis, but sometimes a whole image is a feature region.

The detecting unit 23 sets a condition of image-to-image change detection on the basis of a feature amount of a feature region extracted by the feature-region extracting unit 22 and calculates an image-to-image change amount, thereby detecting a change among a plurality of images. The detecting unit 23 includes an image-change detecting unit 231, an aggregate-change-amount calculating unit 232, and a scene-change-image detecting unit 233.

The image-change detecting unit 231 calculates an image-to-image change amount of each region in a whole area of a target image (including an extracted feature region, a region other than the feature region, and a common region and a mismatched region between the target image and an image to be compared that are generated in accordance with movement of the feature region with respect to the image to be compared) with respect to the image to be compared. The aggregate-change-amount calculating unit 232 sets a condition of image-to-image change detection to be varied on the basis of a feature amount of the extracted feature region, and calculates an image-to-image change amount revised on a region-by-region basis in accordance with the condition of image-to-image change detection, and then accumulates a result of the calculation thereby calculating a statistic as an image-to-image change amount of the whole area of the image. Here, the aggregate-change-amount calculating unit 232 sets a condition of image-to-image change detection so that an image-to-image change of each region in a whole area of a target image is weighted on the basis of a feature amount of a feature region extracted by the feature-region extracting unit 22. Consequently, a region-by-region image change amount is varied relative to a threshold of determination of an image change on the basis of a feature amount of a feature region. The scene-change-image detecting unit 233 compares the statistic on the image-to-image change amount calculated by the aggregate-change-amount calculating unit 232 with a predetermined threshold of determination of an image change, thereby detecting an image having a statistic exceeding the threshold as a scene change image (a summary image). The scene-change-image detecting unit 233 generates a scene change image sequence using detected scene change images (summary images), and serves for the time-series display on the display screen of the display unit 4.

The CPU included in the computer, the scene-change detection device 1 having the above units in the control unit 2 thereof, executes a calculation process for a scene-change detection process by reading a scene-change detection program for executing the scene-change detection process according to the present first embodiment from the ROM in the computer and loading the scene-change detection program in the RAM. The scene-change detection program according to the present first embodiment can be recorded on a computer-readable recording medium, such as a flexible disk, a CD-ROM, a DVD-ROM, or a flash memory, so that the scene-change detection program can be widely distributed. Therefore, the scene-change detection device according to the present first embodiment can be configured to include an auxiliary storage device that can read any of the above-mentioned various recoding media.

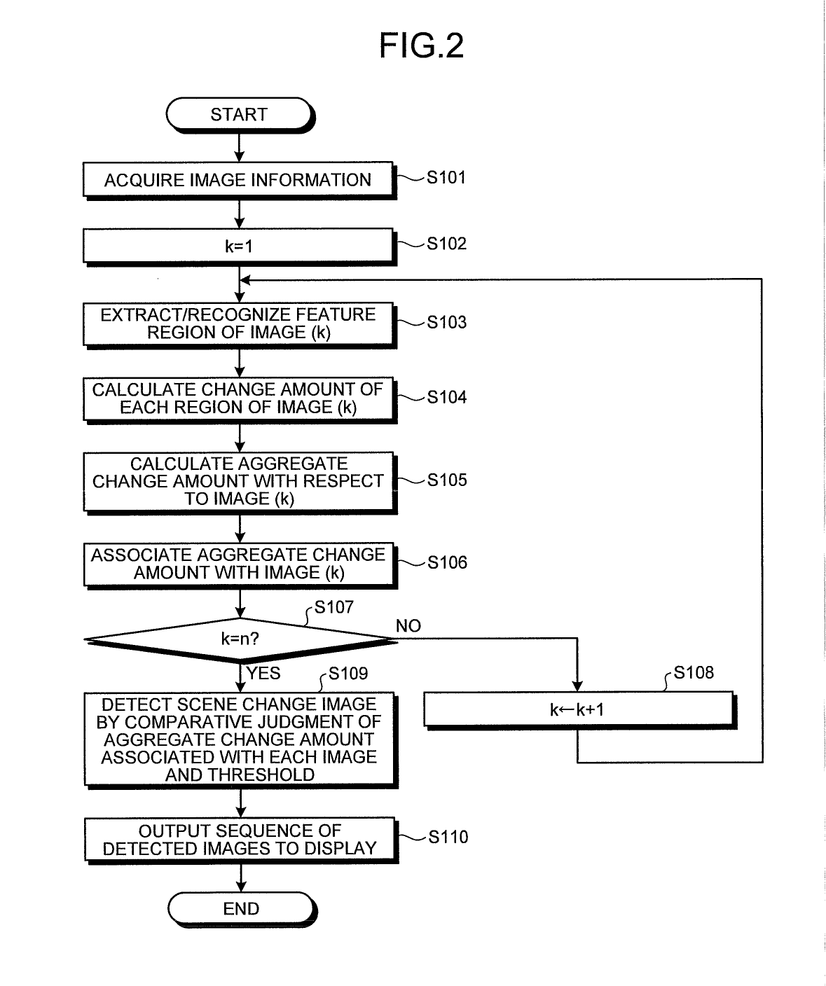

FIG. 2 is a schematic flowchart illustrating a procedure of the scene-change detection process according to the present first embodiment. First, the image reading unit 21 acquires information on n, the number of all images composing a continuous image sequence, the image size, and the like from the storage unit 3, and sequentially reads the images (Step S101). Then, the image reading unit 21 sets a variable k, which indicates what number image for identifying an image to be processed, at 1, which indicates the first image (Step S102). Then, the feature-region extracting unit 22 extracts a feature region from an image (k) with the k-th image (k) as an image to be processed (Step S103). By this process, it turns out that a whole area of the image (k) has a region part other than the feature region, and the whole area of the image (k) is divided into at least a plurality of regions. Namely, the region part other than the extracted feature region can also be treated as a feature region when a condition of detection is set, and it is possible to apply the way of thinking that a whole area of an image is divided into regions and each region is treated as a feature region.

Then, the image-change detecting unit 231 calculates an image-to-image change amount of each region in the whole area of the target image (k) (including the extracted feature region, a region other than the feature region, and a common region and a mismatched region between the target image (k) and an image to be compared that are generated in accordance with movement of the feature region with respect to the image to be compared to be described later) with respect to the image to be compared (Step S104). Then, the aggregate-change-amount calculating unit 232 sets a condition of image-to-image change detection on the basis of a feature amount of the extracted feature region, and calculates an image-to-image change amount revised on a region-by-region basis in accordance with the condition of image-to-image change detection, and then accumulates a result of the calculation thereby calculating a statistic (an aggregate change amount) as an image-to-image change amount of the whole area of the image (Step S105). The calculated statistic is associated with the image (k) as an image change amount of the image (k) (Step S106).

Such processes are repeated in the same manner by incrementing the variable k by +1 until the variable k reaches n, the number of all images (Steps S107 and S108). When the calculation of the statistic with respect to all the images is completed, the scene-change-image detecting unit 233 detects a scene change image by comparative judgment of the statistic associated with each image and a predetermined threshold (Step S109), and outputs a scene change image sequence composed of the detected scene change images to the display unit 4 (Step S110).

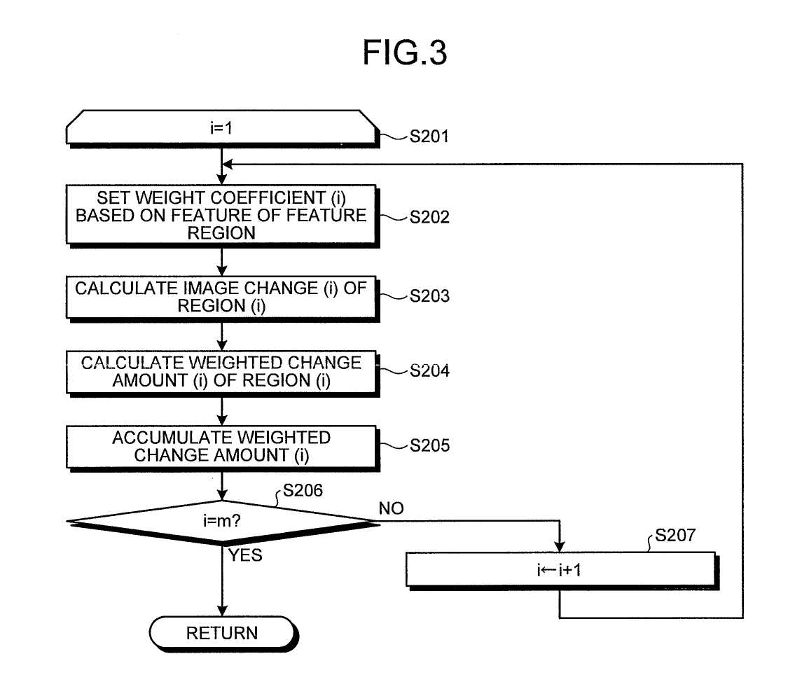

A more detailed process example of the processes at Steps S105 and S106 in FIG. 2 is explained with reference to FIG. 3. Here, the number of regions into which each image is divided on the basis of extraction of a feature region is denoted by m, and a variable identifying each region is denoted by i. First, the variable i is set at 1 (Step S201). Then, the aggregate-change-amount calculating unit 232 sets a weight coefficient (i) of a region (i) on the basis of a feature amount of an extracted feature region of a corresponding image (Step S202). Namely, with respect to the region (i), a condition of image-to-image change detection is set so that an image-to-image change of the region (i) is weighted on the basis of the feature amount of the feature region. Then, the image-change detecting unit 231 calculates an image change amount (i) of the region (i) with respect to an image to be compared (Step S203). Furthermore, the aggregate-change-amount calculating unit 232 calculates a weighted image change amount (i) of the region (i) by multiplying the calculated image change amount (i) by the weight coefficient (i) (Step S204), and accumulates the calculated weighted image change amount (i) to aggregate the weighted image change amount (Step S205). Such processes are repeated in the same manner by incrementing the variable i by +1 until the variable i reaches m, the number of all the regions (Steps S206 and S207).

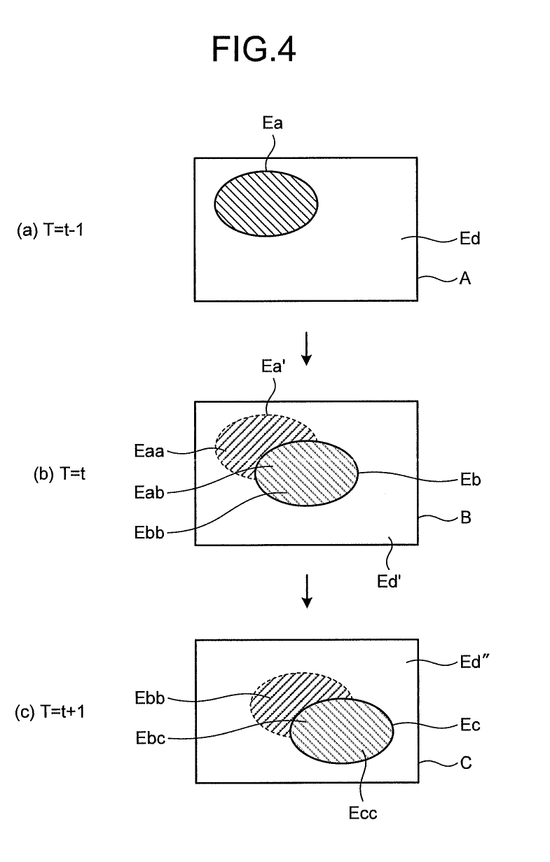

Subsequently, a process for weighting region by region in a whole area of a target image according to the present first embodiment is explained with reference to FIG. 4. FIG. 4 is a schematic explanatory diagram illustrating how, for example, three images in a continuous image sequence are extracted in time-series order. Images A, B, and C are images taken at timings T=t−1, T=t, and T=t+1 in time-series order, respectively, and the image B shall be an attention image to be processed. Furthermore, respective identical feature regions of the images A, B, and C each extracted by the feature-region extracting unit 22 and having a feature amount equivalent to a high level of importance shall be denoted by Ea, Eb, and Ec, respectively.

First, as for the image A, in accordance with the extraction of the feature region Ea, a whole area of the image A is divided into the feature region Ea and a region Ed other than the feature region Ea. Here, it can be thought that the region Ed is also one feature region. Next, the feature region Eb extracted in the attention image B to be processed is the one that the feature region Ea on the image A to be compared moves to another position, and the original position of the feature region Ea is shown as a feature region Ea' on the image B. In this manner, in accordance with the movement of the attention region with respect to the image A to be compared, a common region Eab and mismatched regions Eaa and Ebb between the feature region on the image B and the feature region on the image A to be compared are generated. Furthermore, in accordance with the movement of the feature region, the region Ed also changes to a region Ed' that is not included in both the feature regions Ea and Eb. In the present embodiment, for example, as for the image B, the regions Eaa, Eab, Ebb, and Ed' are treated as regions in a whole area of the image B.

When there is such a movement of the feature region, from a feature amount of each region, it is considered that the common region Eab has the highest level of importance. Thus, weight on an image-to-image change amount of the common region Eab is set high. And, it is considered that the mismatched region Eaa, which is the one that the common region Eab is excluded from the feature region Ea', and the mismatched region Ebb, which is the one that the common region Eab is excluded from the feature region Eb, each have a level of importance lower than that of the common region Eab. Consequently, with respect to the mismatched regions Eaa and Ebb, a corresponding weight coefficient is reduced, and then an image-to-image change amount is calculated. Furthermore, it is considered that the region Ed', which is not included in the feature regions before and after the movement, has a level of importance lower than those of the mismatched regions Eaa and Ebb. Consequently, with respect to the region Ed', a weight coefficient is reduced to be lower than those of the mismatched regions Eaa and Ebb, and then an image-to-image change amount is calculated. Namely, a condition of image-to-image change detection is set so that an image-to-image change of each of the regions Eab, Eaa, Ebb, and Ed' with respect to the image A is weighted by multiplying the image-to-image change by a different weight coefficient depending on a level of importance of each of the regions Eab, Eaa, Ebb, and Ed'.

Then, the weighted image-to-image change amount of each of the regions Eab, Eaa, Ebb, and Ed' is accumulated to calculate a statistic, whereby an aggregate image-to-image change amount of the whole image can be calculated. Namely, a value of an overall image-to-image change amount taking respective levels of importance of the regions in the whole area of the image B into consideration is taken as an image-to-image change amount of the image B. The image-to-image change amount calculated in this way is an image-to-image change amount revised on the basis of the feature amount of the extracted feature region.

Much the same is true on a process when the next image C in time-series order is an object to be processed.

In FIG. 3, if a feature region which is originally low in level of importance is to be extracted, the relation of level of importance described above can be set in an opposite manner. In this case, for example, the common region is treated as a region of the lowest level of importance.

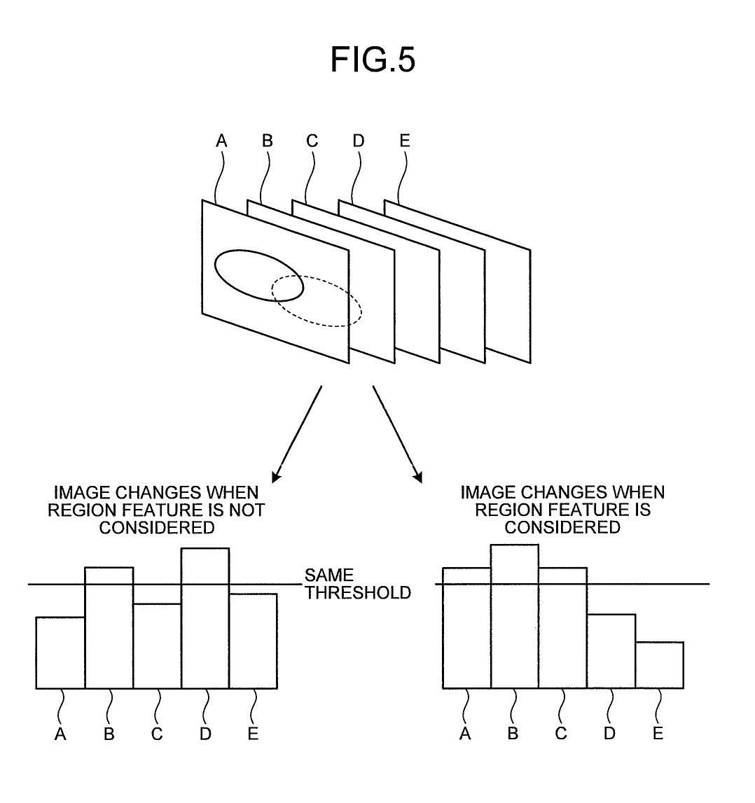

In this manner, when an aggregate image-to-image change amount is obtained as a statistic, the aspect of change differs from a case of an image-to-image change amount obtained by a simple comparison of whole image. For example, FIG. 5 is a schematic diagram illustrating a difference in image-to-image change among five continuous images A to E between when a region feature is not considered as in conventional technologies and when the region feature is considered as in the present first embodiment. When the region feature is not considered as in conventional technologies, a simple comparison of whole image is performed, and if a simple image-to-image change amount of each image exceeds a predetermined threshold (for example, the images B and D), the image is detected as a scene change image. On the other hand, in the present first embodiment, in a case of even the same images A to E, a feature region characterizing image content is extracted from an image to be processed, and a whole area of the image to be processed is divided into a plurality of regions including the feature region, and then a condition of image-to-image change detection is set with each region in the whole area of the image to be processed including a common region and a mismatched region that are generated in accordance with movement of the feature region with respect to the image to be compared attached with a level of importance depending on a feature amount of the feature region by a weight coefficient, whereby a region-by-region image-to-image change amount is varied relative to a predetermined threshold depending on image content. Thus, for example, as for the images A to C, an image-to-image change amount is relatively varied on the side to increase larger than that is in the simple comparison, and even though the predetermined threshold is the same, the images A to C are detected as a scene change image exceeding the threshold. On the other hand, for example, as for the images D and E, an image-to-image change amount is relatively varied on the side to decrease smaller than that is in the simple comparison, and even though the predetermined threshold is the same, the image-to-image change amount does not exceed the threshold, and the images D and E are not detected as a scene change image. Therefore, in detection of a scene change image using the same threshold, a detected scene change image differs between the conventional method and the case of the present first embodiment; however, in the case of the present first embodiment, determination is made by reflecting a level of importance of a feature region in the form of weighting, and thus it is possible to detect an appropriate scene change image based on a feature of a target image.

Namely, in the present first embodiment, when an image has content that one wants to extract the image as a scene change image as much as possible, even if an actual image-to-image change amount is small, the image-to-image change amount is shifted so as to clear a predetermined threshold; on the other hand, when an image has content that one does not want to extract the image as a scene change image as much as possible, even if an actual image-to-image change amount is large, the image-to-image change amount is shifted not to clear a predetermined threshold.

As a feature at the time of calculating an image-to-image change amount, the correlation between images, the SSD (sum of squared differences in pixel), the SAD (sum of absolute differences in pixel), and the like that have been commonly known can be used. Furthermore, a method of dividing an image into regions and performing a similar feature calculation on each region can be used; alternatively, points selected in a regular manner or at regular intervals and a highly-characterized local feature point are calculated, and an amount of motion or an optical flow of each point is obtained, and its magnitude can be used as an image change amount; if a value can be defined as a feature amount, the value can be used as a value for deriving a feature change amount in the present invention.

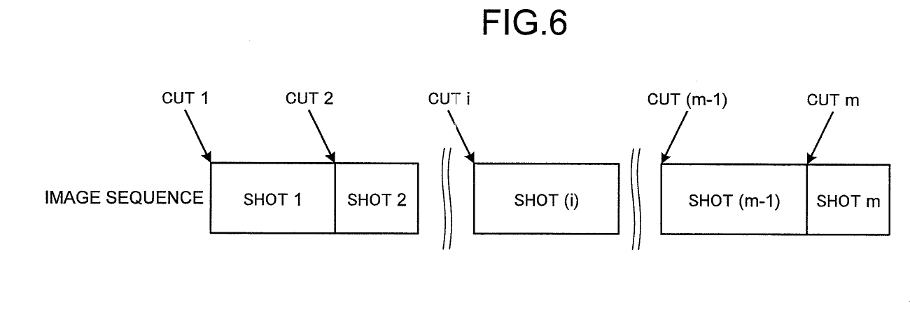

A continuous image sequence processed in the scene-change detection process according to the present first embodiment is, as shown in FIG. 6, that detected scene change images are cut and divided into a plurality of shots, and when the scene change images are actually displayed on the display unit 4, the scene change images are sequentially displayed from the first shot of the scene change image (cuts 1, 2, . . . , i, . . . , n−1, 1). In this display, an image having a small image-to-image change amount is not displayed. In other words, an image having a high degree of similarity is omitted from the display, so it is possible to display images efficiently. At this time, according to the present embodiment, as an image-to-image change amount, as described above, a statistic (an aggregate image change amount) is calculated, and the calculated value is used as an image-to-image change amount, and thus it is possible to detect a more effective scene change image reflecting image content than that is obtained by the conventional method.

In the above explanation, a case of calculating a change in feature between adjacent images in time-series order is explained; however, it is not particularly limited to a process between two adjacent images, and it can be configured that a feature among two or more images is calculated, a value corresponding to a feature change amount is calculated by the statistical operation of a combination of them, and then detection of the set number of images based on the ordering according to the value can be performed.

Furthermore, in a continuous image sequence, similar images may be continued; in such a case, a result of a process performed on an image can be applied to a plurality of continuous images. Namely, in the case of the present first embodiment, a feature region is extracted from an image, and a condition of image-to-image change detection is set on the basis of a feature amount of the feature region, so the same condition of image-to-image change detection is set with respect to a plurality of continuous images. Consequently, it is not necessary to perform a process for extraction/recognition of the feature region with respect to all images, and a processing time can be shortened.

As a technique for determining the number of images to which the above method is applied, simply, the predetermined number of images is just decided in advance, or can be adaptively decided by judging from comparison of an image-to-image similarity with a predetermined threshold.

Moreover, as a feature amount determining a level of importance of a feature region, any of gradation information, brightness information, position information, and size information of the feature region can be used. For example, color gradation information or brightness information is useful information for determining a level of importance of the feature region, so when specific color or brightness information is recognized by using such information, a scene change image can be detected with a high degree of accuracy by setting a level of importance.

Furthermore, using a feature amount based on a position of a feature region as a feature amount of a region is also useful for setting a condition of detection depending on the feature amount of the feature region. Namely, which position within a screen (an image) a feature region is caught on has an association with a level of importance of the feature region, so a condition of detection is set in consideration of a level of importance associated with a position of the feature region, such as a way that if the feature region is caught on near the center of the screen (the image), a level of importance of the feature region is set high; if the feature region is caught on the corner of the screen (the image), a level of importance of the feature region is set low, whereby a scene change image associated with a composition of taken images can be detected effectively.

Moreover, from the viewpoint of the size of the feature region, setting of a level of importance is possible, and an effective scene change image can be detected by setting a level of importance based on the size.

### Second Embodiment

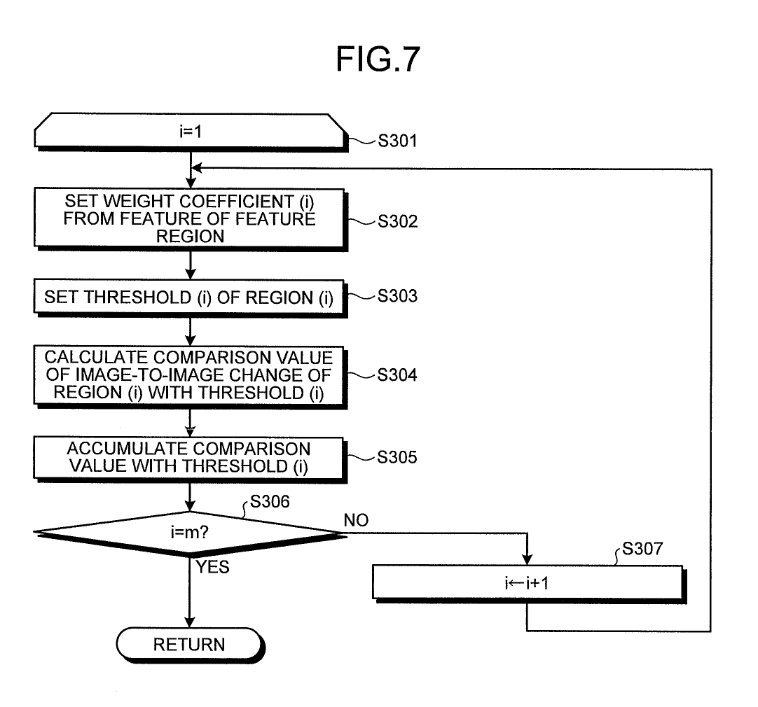

A second embodiment of the present invention is explained with reference to FIG. 7. FIG. 7 is a schematic flowchart illustrating a processing example according to the present second embodiment as an alternative to the processing example in FIG. 3. In the first embodiment, an image-to-image change amount weighted region by region of a target image is calculated and accumulated, and a change among a plurality of images is detected by using a statistic on the weighted image-to-image change amount; in the present second embodiment, by using a threshold weighted region by region of a target image, a difference between the threshold and an image-to-image change is calculated and accumulated, and a change among a plurality of images is detected by using a statistic on the difference. Namely, in the first embodiment, an image change amount is varied by weighting on a region-by-region basis; in the present second embodiment, a threshold is varied by b weighting on a region-by-region basis.

Also in FIG. 7, the number of regions into which each image is divided on the basis of extraction of a feature region is denoted by m, and a variable identifying each region is denoted by i. First, the variable i is set at 1 (Step S301). Then, the aggregate-change-amount calculating unit 232 sets a weight coefficient (i) of a region (i) on the basis of a feature amount of an extracted feature region of a corresponding image (Step S302), and sets a threshold (i) with respect to the region (i) in accordance with the set weight coefficient of the region (i) (Step S303). Namely, with respect to the region (i), the threshold (i) is weighted so that an image-to-image change of the region (i) is relatively weighted on the basis of the feature amount of the feature region, thereby setting a condition of image-to-image change detection. At this time, with respect to an initial, threshold set in advance, it is appropriate that the threshold is set lower with increasing the weight coefficient so as to make it easy to detect, and the threshold is set higher with decreasing the weight coefficient so as to make it hard to detect. Then, the image-change detecting unit 231 calculates a difference between an image change of the region (i) with respect to an image to be compared and the set weighted threshold (i) as a comparison value (Step S304). Furthermore, the aggregate-change-amount calculating unit 232 accumulates the calculated comparison value with the threshold (i) thereby aggregating as a statistic (Step S305). Such processes are repeated in the same manner by incrementing the variable i by +1 until the variable i reaches m, the number of all the regions (Steps S306 and S307).

Also in the case of the present second embodiment, since a threshold is variably set by weighting on a region-by-region basis, a calculated statistic is a value taking a distribution of a level of importance of each region in a whole area of a target image into consideration, and a scene change image sequence is generated by detecting a scene change image by using the statistic calculated on an image-by-image basis as above, and thus it is possible to generate an appropriate scene change image sequence taking a feature amount of a feature region into consideration.

### Example

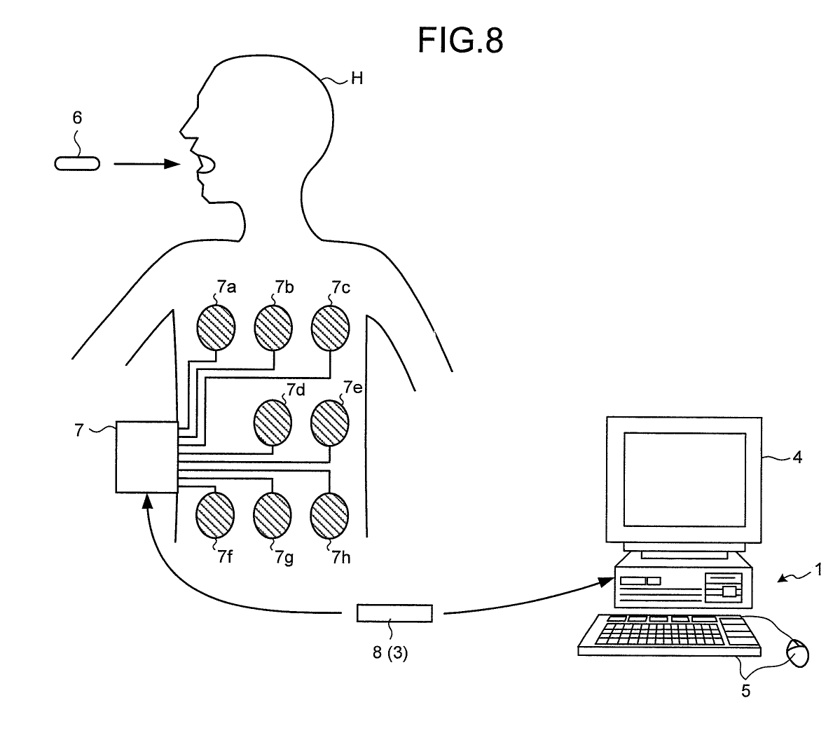

An example of the scene-change detection device according to the present invention is explained with reference to FIG. 8. The present example is that the scene-change detection device 1 according to the above first or second embodiment is used in a capsule endoscope system. FIG. 8 is a configuration diagram schematically illustrating a capsule endoscope system including the scene-change detection device 1 according to the present example as a workstation. The capsule endoscope system includes a capsule endoscope 6 which is introduced into a body cavity of a subject H and takes an image of inside the body cavity, a receiving device 7 which receives a radio signal transmitted from the capsule endoscope 6 and accumulates image information included in the received radio signal, and a portable storage unit 8, such as a memory card, which can be removably attached to the receiving device 7 and the scene-change detection device 1. The storage unit 8 corresponds to the storage unit 3 shown in FIG. 1.

The capsule endoscope 6 has an imaging function of taking an image of inside the body cavity of the subject H and a radio communication function of transmitting a radio signal including the taken image of inside the body cavity to the outside. More specifically, the capsule endoscope 6 takes images of inside the body cavity of the subject H at predetermined intervals (about 2 Hz), for example, about every 0.5 second while moving ahead inside the body cavity of the subject H, and transmits the taken images of inside the body cavity to the receiving device 7 through predetermined radio waves.

A plurality of receiving antennas 7a to 7h for receiving a radio signal transmitted from the capsule endoscope 6 are connected to the receiving device 7. The receiving antennas 7a to 7h are, for example, loop antennas, and arranged on the body surface to be distributed at positions corresponding to a pathway through which the capsule endoscope 6 passes. At least one such receiving antenna has to be arranged with respect to the subject H, and the number of receiving antennas arranged is not limited to eight as illustrated in the drawing.

The receiving device 7 receives a radio signal transmitted from the capsule endoscope 6 via any of the receiving antennas 7a to 7h, and acquires image information of an image of inside the body cavity of the subject H from the received radio signal. The image information acquired by the receiving device 7 is stored in the storage unit 8 attached to the receiving device 7. The storage unit 8 storing therein the image information of the image of inside the body cavity of the subject H is attached to the scene-change detection device 1 to serve for a scene-change detection process in the control unit 2.

An object of such a capsule endoscope system is achieved in such a manner that by using the scene-change detection device 1 having the configuration as explained in the above first or second embodiment, a site of lesion or a site of bleeding is extracted/recognized as a feature region from an image in a sequence of images of inside the body cavity, or a target organ or mucous membrane is extracted/recognized as a feature region, and a condition of image-to-image change detection on a region-by-region basis is set to be varied on the basis of a feature amount of the feature region.

Namely, in a case of handling images of inside the body cavity taken by the capsule endoscope 6, a site of lesion, a site of bleeding, a mucous membrane, various valves, or the like on an image corresponds to an important feature region of the image, so a sufficient number of such images need to be preserved in a scene change image sequence (a summary image sequence). On the other hand, an image of contents suspended in the digestive tract, bubbles, outside of the body before the capsule endoscope 6 is put into the mouth, or the like is low in level of importance even if it includes a feature region, so if a lot of such images are preserved in a scene change image sequence (a summary image sequence), the scene change image sequence (the summary image sequence) is poor quality. Based on such circumstances, as for an image of inside the body cavity, extraction/recognition of a feature region as described above can be made from color information or brightness information of the image although it is a rough extraction/recognition. Consequently, in an image including a feature region of a high level of importance, a condition of detection is set so that an image-to-image change amount of the whole image is relatively increased; on the other hand, in an image including a feature region of a low level of importance, a condition of detection is set so that an image-to-image change amount of the whole image is relatively decreased.

This makes it possible to detect a scene change image depending on a level of importance specific to an image of inside the body cavity taken by the capsule endoscope 6, and thus it is possible to support an effective diagnosis.

According to a scene-change detection device of the present invention, detection of an image-to-image change can be made on a condition of image-to-image change detection in consideration of a feature amount of a feature region. Consequently, it is possible to detect a scene change image in accordance with a feature of an image to which a user pays attention from a sequence of continuous images.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A scene-change detection device for detecting a scene change image from a continuous image sequence on the basis of an amount of change among a plurality of images, the scene-change detection device comprising:
a feature-region extracting unit that extracts a feature region from an image in the image sequence; and
a detecting unit that sets a condition of image-to-image change detection on the basis of a feature amount of the feature region extracted, calculates an image-to-image change amount, and detects a change among a plurality of images.

2. The scene-change detection device according to claim 1, wherein the detecting unit detects a change among a plurality of images by using a statistic on the image-to-image change amount in each of regions in a whole area of the image including the feature region extracted, a region other than the feature region, and a common region and a mismatched region between the image and an image to be compared that are generated in accordance with movement of the feature region with respect to the image to be compared.

3. The scene-change detection device according to claim 2, wherein the detecting unit sets a condition of image-to-image change detection so that an image-to-image change in each of the regions in the whole area of the image is weighted on the basis of the feature amount of the feature region, calculates an image-to-image change amount weighted on a region-by-region basis, and detects a change among a plurality of images by using a statistic on the weighted image-to-image change amount.

4. The scene-change detection device according to claim 1, wherein the detecting unit detects a change among a plurality of images by using a statistic on a difference between a threshold and an image-to-image change in each of regions in a whole area of the image including the feature region extracted, a region other than the feature region, and a common region and a mismatched region between the image and an image to be compared that are generated in accordance with movement of the feature region with respect to the image to be compared.

5. The scene-change detection device according to claim 4, wherein the detecting unit sets a condition of image-to-image change detection so that a threshold of each of the regions in the whole area of the image is weighted on the basis of the feature amount of the feature region, calculates a difference between a region-by-region weighted threshold and a region-by-region image change, and detects a change among a plurality of images by using a statistic on the difference.

6. The scene-change detection device according to claim 1, wherein the detecting unit sets the same condition of image change detection with respect to a plurality of continuous images in the continuous image sequence.

7. The scene-change detection device according to claim 1, wherein at least any one of gradation information, brightness information, position information, and size information of the feature region is used as a feature amount of the feature region.

8. The scene-change detection device according to claim 1, wherein the continuous image sequence is a sequence of images of inside a body cavity taken by a capsule endoscope introduced into the body cavity of a subject.

9. The scene-change detection device according to claim 8, wherein the feature region extracted by the feature-region extracting unit includes a region of a site of lesion, a site of bleeding, or a mucous membrane included in the images of inside the body cavity.

10. A computer readable recording medium including programmed instructions for detecting a scene change image from a continuous image sequence on the basis of an amount of change among a plurality of images, wherein the instructions, when executed by a computer, cause the computer to perform:
extracting a feature region from an image in the image sequence;
setting a condition of image-to-image change detection on the basis of a feature amount of the feature region extracted, calculating an image-to-image change amount; and
detecting a change among a plurality of images.
